(19) United States
(12) Patent Application Publication
(10) Pub. No.: US 2025/0235993 A1
(43) Pub. Date: Jul. 24, 2025

(54) ELECTRONIC TORQUE WRENCH WITH REMOTE TARGET TORQUE SETTING

(71) Applicant: Apex Brands, Inc., Apex, NC (US)

(72) Inventors: Minglin Shi, Shanghai (CN); Henglian Luo, Shanghai (CN); Bin Sun, Shanghai (CN); Zheng Xu, Shanghai (CN)

(21) Appl. No.: 18/855,510

(22) PCT Filed: Apr. 11, 2022
(86) PCT No.: PCT/CN2022/086028

§ 371 Date: Oct. 9, 2024

(51) Int. Cl. B25B 23/142

(52) U.S. Cl. CPC B25B 23/1425

(57) ABSTRACT

An apparatus such as an electronic torque wrench is provided that includes a communication interface, strain gauge assembly, analog-to-digital converter (ADC) and processing circuitry. The communication interface is configured to enable the apparatus to telecommunicate with a computer or computer hardware. The strain gauge assembly is configured to measure an applied torque, and produce an analog electrical signal that varies in voltage with the applied torque; and the analog-to-digital converter is configured to convert the analog electrical signal to an equivalent digital electrical signal. The processing circuitry is configured to receive an indication of a target torque from the computer or computer hardware via the communication interface, determine the applied torque from the equivalent digital electrical signal, perform a comparison of the target torque and the applied torque, and output an indication of the applied torque based on the comparison.

### TECHNOLOGICAL FIELD

The present disclosure relates generally to torque application and measurement devices and, in particular, to an apparatus for torque measurement such as an electronic torque wrench.

### BACKGROUND

Fasteners are often used to assemble performance critical components are tightened to a specified torque level to introduce a “pretension” in the fastener. As torque is applied to the head of the fastener, the fastener may begin to stretch beyond a certain level of applied torque. This stretch results in the pretension in the fastener which then holds the components together. Additionally, it is often necessary to further rotate the fastener through a specified angle after the desired torque level has been applied. A popular method of tightening these fasteners is to use a torque wrench.

Torque wrenches may be of mechanical or electronic type. Mechanical torque wrenches are generally less expensive than electronic. There are two common types of mechanical torque wrenches, beam and clicker types. In a beam type torque wrench, a beam bends relative to a non-deflecting beam in response to applied torque. The amount of deflection of the bending beam relative to the non-deflecting beam indicates the amount of torque applied to the fastener. Clicker type torque wrenches have a selectable preloaded snap mechanism with a spring to release at a specified, target torque, thereby generating a click noise.

Electronic torque wrenches tend to be more expensive than mechanical torque wrenches. Many electronic torque wrenches include a user interface with a human input device and an electronic visual display. The electronic torque wrench may receive a target torque through its user interface; and when applying torque to a fastener with an electronic torque wrench, torque readings may be indicated on the electronic visual display that relate to the pretension in the fastener due to the applied torque.

It is generally known that mechanical torque wrenches have a sometimes awkward mechanism for setting a target torque. Electronic torque wrenches offer an often easier mechanism, but electronic torque wrenches also include more delicate user interface electronics that can be prone to damage. It would therefore be desirable to have a system and method that takes into account at least some of the issues discussed above, as well as other possible issues.

### BRIEF SUMMARY

Example implementations of the present disclosure are directed to an apparatus such as an electronic torque wrench for torque measurement with remote target torque setting. The present disclosure includes, without limitation, the following example implementations.

Some example implementations provide an apparatus for determining an applied torque, the apparatus comprising: a communication interface configured to enable the apparatus to telecommunicate with a computer or computer hardware that is separate and distinct from the apparatus; a strain gauge assembly configured to measure the applied torque, and produce an analog electrical signal that varies in voltage with the applied torque; an analog-to-digital converter configured to convert the analog electrical signal to an equivalent digital electrical signal; and processing circuitry operably coupled to the communication interface and the analog-to-digital converter, the processing circuitry configured to at least: receive an indication of a target torque from the computer or computer hardware via the communication interface; determine the applied torque from the equivalent digital electrical signal; perform a comparison of the target torque and the applied torque; and output an indication of the applied torque based on the comparison.

Some example implementations provide a method of determining an applied torque at an apparatus including a communication interface configured to enable the apparatus to telecommunicate with a computer or computer hardware that is separate and distinct from the apparatus, the method comprising: receiving an indication of a target torque from the computer or computer hardware via the communication interface; measuring the applied torque, and producing an analog electrical signal that varies in voltage with the applied torque; converting the analog electrical signal to an equivalent digital electrical signal; determining the applied torque from the equivalent digital electrical signal; performing a comparison of the target torque and the applied torque; and outputting an indication of the applied torque based on the comparison.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates an electronic torque wrench, according to some example implementations of the present disclosure;

FIG. 2 is a block diagram of an apparatus for determining an applied torque, and that may correspond to the electronic torque wrench of FIG. 1, according to some example implementations;

FIGS. 3A, 3B, 3C, 3D and 3E are flowcharts illustrating various steps in a method of determining an applied torque, according to example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

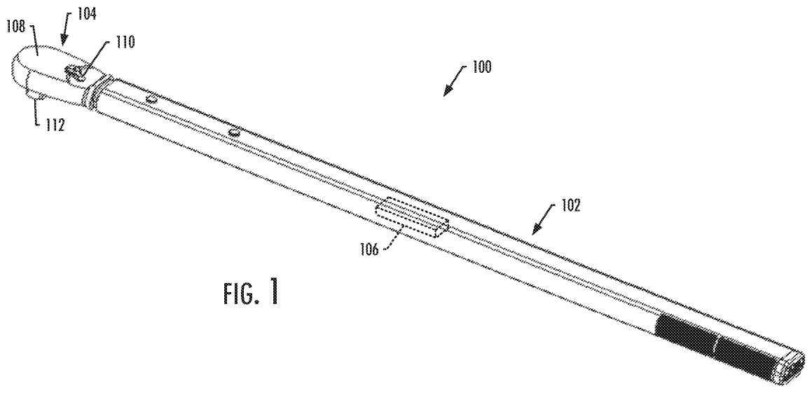

Example implementations of the present disclosure relate generally to torque application and measurement devices. Example implementations will primarily be described in the context of an electronic torque wrench. Other examples of suitable apparatuses for torque measurement include a torque tester, torque meter, torque transducer or the like. FIG. 1 illustrates an electronic torque wrench 100 according to some example implementations of the present disclosure. As shown, the electronic torque wrench includes a wrench body 102 and a wrench head 104 (e.g., a ratcheting wrench head). In some examples, the wrench body is of tubular construction, made of steel or other rigid material, and receives the wrench head at a first end. In some examples, the wrench body carries an electronics unit 106, which in some examples may include various electronic components and circuitry mounted on a circuit board.

As shown, a front end 108 of the wrench head 104 includes a coupler with a lever 110 that allows a user to select whether torque is applied to a fastener in either a clockwise (CW) or counter-clockwise (CCW) direction. A mechanism includes a boss 112 for receiving variously sized sockets, extensions, etc. A rear end of the wrench head is received in the wrench body 102 and rigidly secured therein. A portion of the wrench head secured in the wrench body carries a strain gauge assembly that includes one or more strain gauges. In some examples, the strain gauge assembly is a full-bridge assembly including four separate strain gauges on a single film that is secured to the portion of the wrench head secured in the wrench body. Together, the full-bridge strain gauge assembly mounted on the wrench head is referred to as a strain tensor.

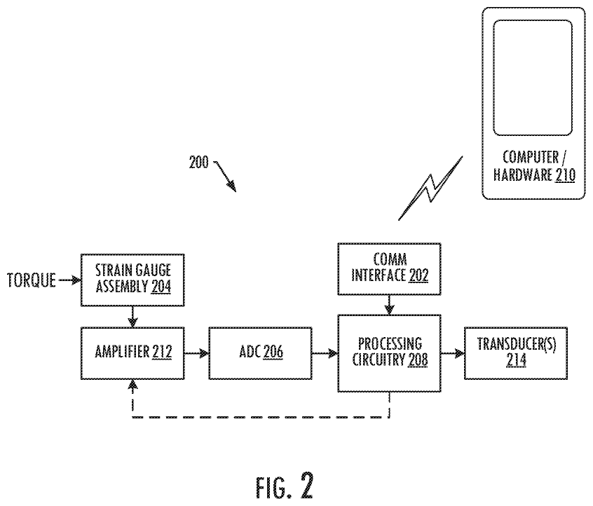

FIG. 2 illustrates an apparatus 200 for determining a torque value of an applied torque, according to some example implementations. The apparatus may be embodied in a number of different manners, and in some examples, the apparatus is an electronic torque wrench such as electronic torque wrench 100 configured to apply to a fastener. In other examples, the apparatus is a torque tester, torque meter, torque transducer or the like. As shown, the apparatus includes a communication interface 202, a strain gauge assembly 204, an analog-to-digital converter (ADC) 206, and processing circuitry 208. In some examples in which the apparatus 200 corresponds to electronic torque wrench 100, the communication interface, ADC and processing circuitry may be components of the electronics unit 106. According to some example implementations, the apparatus excludes a human input device (a device such as a keyboard or keypad that takes input from humans) to receive the target torque. In some of these examples, the apparatus also excludes an electronic visual display (a display device for presentation of textual or graphic information transmitted electronically) to provide a visual presentation of the target torque as received.

The communication interface 202 is configured to enable the apparatus 200 to telecommunicate with a computer or computer hardware 210 that is separate and distinct from the apparatus. As described herein, the communication interface is an electronic circuit; and in various examples, the communication interface includes a cable connector, an antenna or optoelectronics for the electronic transmission of information. Examples of suitable communication interfaces include a network interface controller (NIC), wireless NIC (WNIC) or the like.

The computer or computer hardware 210 may be embodied in any of a number of different manners. Examples of suitable computers and computer hardware include personal computers (PCs), handheld computers, mobile phones), remote controls, dongles or the like. Examples of handheld computers include mobile computers such as tablet computers, laptops and the like, mobile phones such as smartphones, wearable computers such as smartwatches, and the like.

In various examples, the communication interface 202 is configured to enable the apparatus 200 to telecommunicate with the computer or computer hardware 210 by wire, or wirelessly by radio or optical communication. In some more particular examples, the communication interface may be configured to enable the apparatus to telecommunicate over a wired or wireless personal area network (PAN) or local area network (LAN) between the apparatus and the computer hardware. The communication interface may be designed one or more communication standards such as universal serial bus (USB), universal asynchronous receiver-transmitter (UART) or Ethernet. Additionally, or alternatively, the communication interface may be designed to one or more communication standards such as Bluetooth, Bluetooth Low Energy, Wi-Fi, frequency-shift keying (FSK) or Infrared Data Association (IrDA).

The strain gauge assembly 204 is configured to measure an applied torque such as the torque applied to a fastener when the apparatus 200 is an electronic torque wrench, and produce an analog electrical signal that varies in voltage with the applied torque. In some examples, the apparatus includes an amplifier 212 configured to receive the analog electrical signal, and increase an amplitude of the analog electrical signal to produce an amplified analog electrical signal. The ADC 206 is configured to convert the (amplified) analog electrical signal to an equivalent digital electrical signal.

In various examples, the processing circuitry 208 is configured to transmit first data to the computer or computer hardware 210 via the communication interface 202. Additionally, or alternatively, in various examples, the processing circuitry is configured to receive second data from the computer or computer hardware via the communication interface. The first data may include configuration data such as a target torque or other configuration data, instruction data, or the like. The second data may include an indication of the applied torque determined by the processing circuitry. In other examples, the second data may include verification data, checksum or the like.

In some more particular examples, the processing circuitry 208 is configured to receive an indication of a target torque from the computer or computer hardware 210 via the communication interface 202, and determine the applied torque from the equivalent digital electrical signal output by the ADC 206. In some examples, the equivalent digital electrical signal includes digital data points; and in some of these examples, the processing circuitry is configured to determine a subset of the digital data points in a moving sample window, and determine the applied torque from a rolling average of the subset of the digital data points in the moving sample window.

To further illustrate use of the rolling average, consider an example in which the processing circuitry 208 samples one thousand digital data points per second and uses a moving sample window of ten milliseconds. As torque is applied, the processing circuitry may average the first ten digital data points, one taken each millisecond, thereby producing a first equivalent digital value at time t=0.01 seconds, wherein t=0.0 seconds marks initiation of the torquing operation. At time t=0.011 seconds, the processing circuitry may average the digital data points taken between times t=0.002 and t=0.011 seconds, thereby producing a second equivalent digital value. At time t=0.012 seconds, the processing circuitry may average the digital data points taken between times t=0.003 seconds and t=0.012 seconds, thereby producing a third equivalent digital value. And this may continue such that an equivalent digital value may be provided every millisecond until the torque is no longer applied. In short, the processing circuitry may utilize a digital filtering algorithm to provide a rolling average in which the oldest digital data point is dropped each time a new digital data point is received within the moving sample window.

The processing circuitry 208 is configured to perform a comparison of the target torque and the applied torque, and output an indication of the applied torque based on the comparison. In some examples, the processing circuitry is configured to determine the applied torque matches the target torque, and output the indication of the applied torque as an indication that the applied torque matches the target torque. And in some of these examples, the processing circuitry is configured to determine the applied torque matches the target torque when the applied torque is within a threshold torque of the target torque.

The processing circuitry 208 may output the indication of the applied torque in a number of different manners. In some examples, the apparatus 200 further includes one or more transducers 214 operably coupled to the processing circuitry. In some of these examples, the processing circuitry is configured to output the indication of the applied torque as an output signal, and the one or more transducers are configured to convert the output signal to user-perceptible feedback. In various examples, the one or more transducers include one or more of an electromechanical transducer, an electroacoustic transducer or one or more electro-optical transducers. In this regard, an electromechanical transducer is configured to convert the output signal to haptic feedback. Examples of suitable electromechanical transducers include eccentric rotating mass (ERM) actuators, a linear resonant actuators (LRAs), piezoelectric actuators and the like

An electroacoustic transducer such as a loudspeaker is configured to convert the output signal to audible feedback. An electro-optical transducer is configured to convert the output signal to visual feedback. Examples of suitable electro-optical transducers include light emitting diode (LED) indicators.

The processing circuitry 208 of example implementations of the present disclosure may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). In more particular examples, the processing circuitry may be embodied as or include a processor, coprocessor, controller, microprocessor, microcontroller, application specific integrated circuit (ASIC), field programmable gate array (FPGA) or the like.

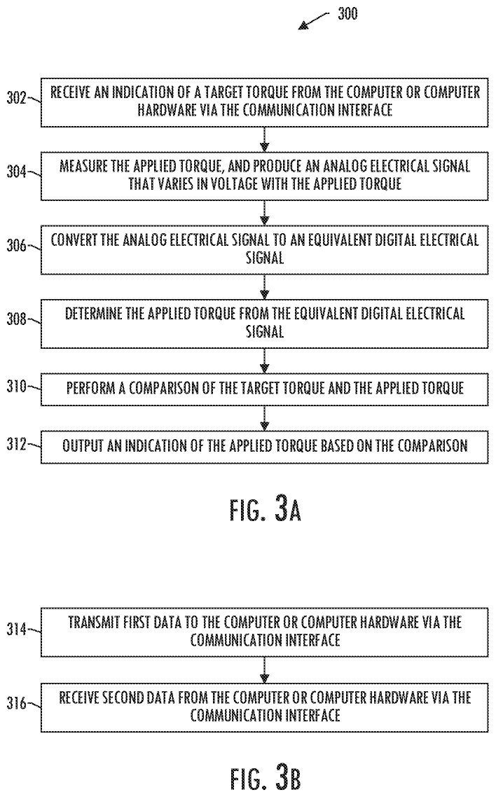

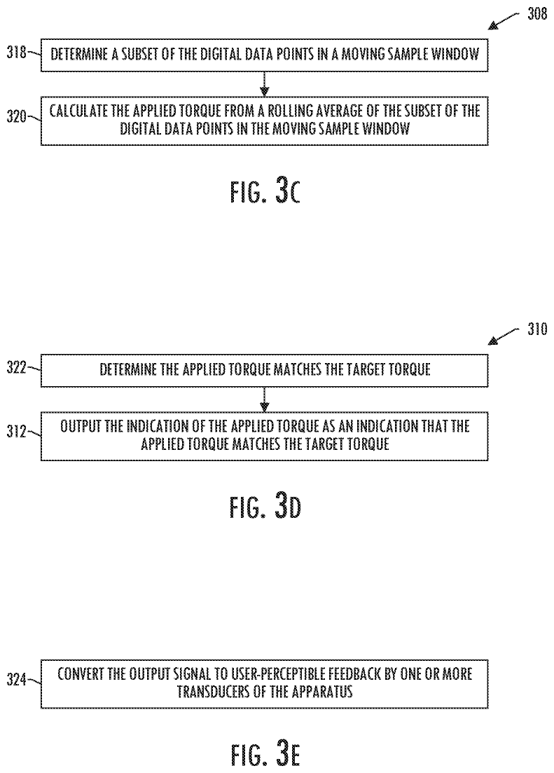

FIGS. 3A-3E are flowcharts illustrating various steps in a method 300 of determining an applied torque at an apparatus including a communication interface that enables the apparatus to telecommunicate with a computer or computer hardware that is separate and distinct from the apparatus, according to various example implementations of the present disclosure. The method includes receiving an indication of a target torque from the computer or computer hardware via the communication interface, as shown at block 302 of FIG. 3A. The method includes measuring the applied torque, and producing an analog electrical signal that varies in voltage with the applied torque, as shown at block 304. The method includes converting the analog electrical signal to an equivalent digital electrical signal, as shown at block 306. The method includes determining the applied torque from the equivalent digital electrical signal, as shown at block 308. The method includes performing a comparison of the target torque and the applied torque, as shown at block 310. And the method includes outputting an indication of the applied torque based on the comparison, as shown at block 312.

In some examples, the method 300 further comprises transmitting first data to the computer or computer hardware via the communication interface, and receiving second data from the computer or computer hardware via the communication interface, as shown at blocks 314 and 316 of FIG. 3B.

In some examples, the apparatus is embodied as an electronic torque wrench, the applied torque that is measured at block 304 is a torque applied by the electronic torque wrench to a fastener.

In some examples, the computer or computer hardware includes a personal computer, handheld computer, remote control or dongle, and the indication of the target torque is received at block 302 via the communication interface that enables the apparatus to telecommunicate with the personal computer, handheld computer, remote control or dongle.

In some examples, target torque is received at block 302 without a human input device of the apparatus to receive the target torque, and without an electronic visual display of the apparatus to provide a visual presentation of the target torque as received.

In some examples, the indication of the target torque is received at block 302 via the communication interface that enables the apparatus to telecommunicate with the computer or computer hardware by wire, or wirelessly by radio or optical communication.

In some examples, the indication of the target torque is received at block 302 via the communication interface that enables the apparatus to telecommunicate over a wired or wireless personal area network (PAN) or local area network (LAN) between the apparatus and the computer hardware.

In some examples, the indication of the target torque is received at block 302 via the communication interface that is designed to one or more communication standards including one or more of universal serial bus (USB), universal asynchronous receiver-transmitter (UART) or Ethernet.

In some examples, the indication of the target torque is received at block 302 via the communication interface that is designed to one or more communication standards including one or more of Bluetooth, Bluetooth Low Energy, Wi-Fi, frequency-shift keying (FSK) or Infrared Data Association (IrDA)

In some examples, the equivalent digital electrical signal includes digital data points, and determining the applied torque at block 308 includes determining a subset of the digital data points in a moving sample window, as shown at block 318 of FIG. 3C. And the method includes calculating the applied torque from a rolling average of the subset of the digital data points in the moving sample window, as shown at block 320.

In some examples, performing the comparison at block 310 includes determining the applied torque matches the target torque, as shown at block 322 of FIG. 3D. In some of these examples, the indication of the applied torque is output at block 312 as an indication that the applied torque matches the target torque.

In some examples, the applied torque matches the target torque when the applied torque is within a threshold torque of the target torque.

In some examples, the indication of the applied torque is output at block 312 as an output signal, and the method further includes converting the output signal to user-perceptible feedback by one or more transducers of the apparatus, as shown at block 324 of FIG. 3E.

In some examples, the one or more transducers include an electromechanical transducer converting the output signal to haptic feedback at block 324.

In some examples, the electromechanical transducer includes an eccentric rotating mass (ERM) actuator, a linear resonant actuator (LRA) or a piezoelectric actuator.

In some examples, the one or more transducers include an electroacoustic transducer converting the output signal to audible feedback at block 324.

In some examples, the electroacoustic transducer includes a loudspeaker.

In some examples, the one or more transducers include one or more electro-optical transducers converting the output signal to visual feedback at block 324, and the one or more electro-optical transducers include one or more light emitting diode (LED) indicators.

As explained above and reiterated below, the present disclosure includes, without limitation, the following example implementations.
Clause 1. An apparatus for determining an applied torque, the apparatus comprising: a communication interface configured to enable the apparatus to telecommunicate with a computer or computer hardware that is separate and distinct from the apparatus; a strain gauge assembly configured to measure the applied torque, and produce an analog electrical signal that varies in voltage with the applied torque; an analog-to-digital converter configured to convert the analog electrical signal to an equivalent digital electrical signal; and processing circuitry operably coupled to the communication interface and the analog-to-digital converter, the processing circuitry configured to at least: receive an indication of a target torque from the computer or computer hardware via the communication interface; determine the applied torque from the equivalent digital electrical signal; perform a comparison of the target torque and the applied torque; and output an indication of the applied torque based on the comparison.
Clause 2. The apparatus of clause 1, wherein the processing circuitry is further configured to: transmit first data to the computer or computer hardware via the communication interface; and receive second data from the computer or computer hardware via the communication interface.
Clause 3. The apparatus of clause 1, wherein the apparatus is embodied as an electronic torque wrench, and the applied torque is a torque that the electronic torque wrench is configured to apply to a fastener.
Clause 4. The apparatus of any of clauses 1 to 3, wherein the computer or computer hardware includes a personal computer, handheld computer, remote control or dongle, and the processing circuitry is configured to receive the indication of the target torque via the communication interface that is configured to enable the apparatus to telecommunicate with the personal computer, handheld computer, remote control or dongle.
Clause 5. The apparatus of any of clauses 1 to 4, wherein the apparatus excludes a human input device to receive the target torque, and the apparatus excludes an electronic visual display to provide a visual presentation of the target torque as received.
Clause 6. The apparatus of any of clauses 1 to 5, wherein the processing circuitry is configured to receive the indication of the target torque via the communication interface that is configured to enable the apparatus to telecommunicate with the computer or computer hardware by wire, or wirelessly by radio or optical communication.
Clause 7. The apparatus of any of clauses 1 to 6, wherein the processing circuitry is configured to receive the indication of the target torque via the communication interface that is configured to enable the apparatus to telecommunicate over a wired or wireless personal area network (PAN) or local area network (LAN) between the apparatus and the computer hardware.
Clause 8. The apparatus of any of clauses 1 to 7, wherein the processing circuitry is configured to receive the indication of the target torque via the communication interface that is designed to one or more communication standards including one or more of universal serial bus (USB), universal asynchronous receiver-transmitter (UART) or Ethernet.
Clause 9. The apparatus of any of clauses 1 to 8, wherein the processing circuitry is configured to receive the indication of the target torque via the communication interface that is designed to one or more communication standards including one or more of Bluetooth, Bluetooth Low Energy, Wi-Fi, frequency-shift keying (FSK) or Infrared Data Association (IrDA).
Clause 10. The apparatus of any of clauses 1 to 9, wherein the equivalent digital electrical signal includes digital data points, and the processing circuitry configured to determine the applied torque includes the processing circuitry configured to: determine a subset of the digital data points in a moving sample window; and calculate the applied torque from a rolling average of the subset of the digital data points in the moving sample window.
Clause 11. The apparatus of any of clauses 1 to 10, wherein the processing circuitry configured to perform the comparison includes the processing circuitry configured to determine the applied torque matches the target torque, the processing circuitry configured to output the indication of the applied torque as an indication that the applied torque matches the target torque.
Clause 12. The apparatus of clause 11, wherein the processing circuitry is configured to determine the applied torque matches the target torque when the applied torque is within a threshold torque of the target torque.
Clause 13. The apparatus of any of clauses 1 to 12, wherein the processing circuitry is configured to output the indication of the applied torque as an output signal, and wherein the apparatus further comprises one or more transducers operably coupled to the processing circuitry, and configured to convert the output signal to user-perceptible feedback.
Clause 14. The apparatus of clause 13, wherein the one or more transducers include an electromechanical transducer configured to convert the output signal to haptic feedback.
Clause 15. The apparatus of clause 14, wherein the electromechanical transducer includes an eccentric rotating mass (ERM) actuator, a linear resonant actuator (LRA) or a piezoelectric actuator.
Clause 16. The apparatus of any of clauses 13 to 15, wherein the one or more transducers include an electroacoustic transducer configured to convert the output signal to audible feedback.
Clause 17. The apparatus of clause 16, wherein the electroacoustic transducer includes a loudspeaker.
Clause 18. The apparatus of any of clauses 13 to 17, wherein the one or more transducers include one or more electro-optical transducers configured to convert the output signal to visual feedback, and the one or more electro-optical transducers include one or more light emitting diode (LED) indicators.
Clause 19. A method of determining an applied torque at an apparatus including a communication interface configured to enable the apparatus to telecommunicate with a computer or computer hardware that is separate and distinct from the apparatus, the method comprising: receiving an indication of a target torque from the computer or computer hardware via the communication interface; measuring the applied torque, and producing an analog electrical signal that varies in voltage with the applied torque; converting the analog electrical signal to an equivalent digital electrical signal; determining the applied torque from the equivalent digital electrical signal; performing a comparison of the target torque and the applied torque; and outputting an indication of the applied torque based on the comparison.
Clause 20. The method of clause 19, wherein the method further comprises: transmitting first data to the computer or computer hardware via the communication interface; and receiving second data from the computer or computer hardware via the Clause 21. The method of clause 19, wherein the apparatus is embodied as an electronic torque wrench, the applied torque that is measured is a torque applied by the electronic torque wrench to a fastener.
Clause 22. The method of any of clauses 19 to 21, wherein the computer or computer hardware includes a personal computer, handheld computer, remote control or dongle, and the indication of the target torque is received via the communication interface that enables the apparatus to telecommunicate with the personal computer, handheld computer, remote control or dongle.
Clause 23. The method of any of clauses 19 to 22, wherein target torque is received without a human input device of the apparatus to receive the target torque, and without an electronic visual display of the apparatus to provide a visual presentation of the target torque as received.
Clause 24. The method of any of clauses 19 to 23, wherein the indication of the target torque is received via the communication interface that enables the apparatus to telecommunicate with the computer or computer hardware by wire, or wirelessly by radio or optical communication.
Clause 25. The method of any of clauses 19 to 24, wherein the indication of the target torque is received via the communication interface that enables the apparatus to telecommunicate over a wired or wireless personal area network (PAN) or local area network (LAN) between the apparatus and the computer hardware.
Clause 26. The method of any of clauses 19 to 25, wherein the indication of the target torque is received via the communication interface that is designed to one or more communication standards including one or more of universal serial bus (USB), universal asynchronous receiver-transmitter (UART) or Ethernet.
Clause 27. The method of any of clauses 19 to 26, wherein the indication of the target torque is received via the communication interface that is designed to one or more communication standards including one or more of Bluetooth, Bluetooth Low Energy, Wi-Fi, frequency-shift keying (FSK) or Infrared Data Association (IrDA).
Clause 28. The method of any of clauses 19 to 27, wherein the equivalent digital electrical signal includes digital data points, and determining the applied torque includes: determining a subset of the digital data points in a moving sample window; and calculating the applied torque from a rolling average of the subset of the digital data points in the moving sample window.
Clause 29. The method of any of clauses 19 to 28, wherein performing the comparison includes determining the applied torque matches the target torque, the indication of the applied torque output as an indication that the applied torque matches the target torque.
Clause 30. The method of clause 29, wherein the applied torque matches the target torque when the applied torque is within a threshold torque of the target torque.
Clause 31. The method of any of clauses 19 to 30, wherein the indication of the applied torque is output as an output signal, and the method further comprises converting the output signal to user-perceptible feedback by one or more transducers of the apparatus.
Clause 32. The method of clause 31, wherein the one or more transducers include an electromechanical transducer converting the output signal to haptic feedback.
Clause 33. The method of clause 32, wherein the electromechanical transducer includes an eccentric rotating mass (ERM) actuator, a linear resonant actuator (LRA) or a piezoelectric actuator.
Clause 34. The method of any of clauses 31 to 33, wherein the one or more transducers include an electroacoustic transducer converting the output signal to audible feedback.
Clause 35. The method of clause 34, wherein the electroacoustic transducer includes a loudspeaker.
Clause 36. The method of any of clauses 31 to 35, wherein the one or more transducers include one or more electro-optical transducers converting the output signal to visual feedback, and the one or more electro-optical transducers include one or more light emitting diode (LED) indicators.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for determining an applied torque, the apparatus comprising:
a communication interface configured to enable the apparatus to telecommunicate with a computer or computer hardware that is separate and distinct from the apparatus;
a strain gauge assembly configured to measure the applied torque, and produce an analog electrical signal that varies in voltage with the applied torque;
an analog-to-digital converter configured to convert the analog electrical signal to an equivalent digital electrical signal; and
processing circuitry operably coupled to the communication interface and the analog-to-digital converter, the processing circuitry configured to at least:
receive an indication of a target torque from the computer or computer hardware via the communication interface;
determine the applied torque from the equivalent digital electrical signal;
perform a comparison of the target torque and the applied torque; and
output an indication of the applied torque based on the comparison.

2. The apparatus of claim 1, wherein the processing circuitry is further configured to:
transmit first data to the computer or computer hardware via the communication interface; and
receive second data from the computer or computer hardware via the communication interface.

3. The apparatus of claim 1, wherein the computer or computer hardware includes a personal computer, handheld computer, remote control or dongle, and the processing circuitry is configured to receive the indication of the target torque via the communication interface that is configured to enable the apparatus to telecommunicate with the personal computer, handheld computer, remote control or dongle.

4. The apparatus of claim 1, wherein the apparatus excludes a human input device to receive the target torque, and the apparatus excludes an electronic visual display to provide a visual presentation of the target torque as received.

5. The apparatus of claim 1, wherein the processing circuitry is configured to receive the indication of the target torque via the communication interface that is configured to enable the apparatus to telecommunicate with the computer or computer hardware by wire, or wirelessly by radio or optical communication.

6. The apparatus of claim 1, wherein the processing circuitry is configured to receive the indication of the target torque via the communication interface that is configured to enable the apparatus to telecommunicate over a wired or wireless personal area network (PAN) or local area network (LAN) between the apparatus and the computer hardware.

7. The apparatus of claim 1, wherein the processing circuitry is configured to receive the indication of the target torque via the communication interface that is designed to one or more communication standards including one or more of universal serial bus (USB), universal asynchronous receiver-transmitter (UART) or Ethernet.

8. The apparatus of claim 1, wherein the processing circuitry is configured to receive the indication of the target torque via the communication interface that is designed to one or more communication standards including one or more of Bluetooth, Bluetooth Low Energy, Wi-Fi, frequency-shift keying (FSK) or Infrared Data Association (IrDA).

9. The apparatus of claim 1, wherein the processing circuitry is configured to output the indication of the applied torque as an output signal, and
wherein the apparatus further comprises one or more transducers operably coupled to the processing circuitry, and configured to convert the output signal to user-perceptible feedback.

10. The apparatus of claim 9, wherein the one or more transducers include an electromechanical transducer configured to convert the output signal to haptic feedback, or an electroacoustic transducer configured to convert the output signal to audible feedback.

11. The apparatus of claim 9, wherein the one or more transducers include one or more electro-optical transducers configured to convert the output signal to visual feedback, and the one or more electro-optical transducers include one or more light emitting diode (LED) indicators.

12. A method of determining an applied torque at an apparatus including a communication interface configured to enable the apparatus to telecommunicate with a computer or computer hardware that is separate and distinct from the apparatus, the method comprising:
receiving an indication of a target torque from the computer or computer hardware via the communication interface;
measuring the applied torque, and producing an analog electrical signal that varies in voltage with the applied torque;
converting the analog electrical signal to an equivalent digital electrical signal;
determining the applied torque from the equivalent digital electrical signal;
performing a comparison of the target torque and the applied torque; and
outputting an indication of the applied torque based on the comparison.

13. The method of claim 12, wherein the method further comprises:
transmitting first data to the computer or computer hardware via the communication interface; and
receiving second data from the computer or computer hardware via the

14. The method of claim 12, wherein the computer or computer hardware includes a personal computer, handheld computer, remote control or dongle, and the indication of the target torque is received via the communication interface that enables the apparatus to telecommunicate with the personal computer, handheld computer, remote control or dongle.

15. The method of claim 12, wherein target torque is received without a human input device of the apparatus to receive the target torque, and without an electronic visual display of the apparatus to provide a visual presentation of the target torque as received.

16. The method of claim 12, wherein the indication of the target torque is received via the communication interface that enables the apparatus to telecommunicate with the computer or computer hardware by wire, or wirelessly by radio or optical communication.

17. The method of claim 12, wherein the indication of the target torque is received via the communication interface that enables the apparatus to telecommunicate over a wired or wireless personal area network (PAN) or local area network (LAN) between the apparatus and the computer hardware.

18. The method of claim 12, wherein the indication of the target torque is received via the communication interface that is designed to one or more communication standards including one or more of universal serial bus (USB), universal asynchronous receiver-transmitter (UART) or Ethernet.

19. The method of claim 12, wherein the indication of the target torque is received via the communication interface that is designed to one or more communication standards including one or more of Bluetooth, Bluetooth Low Energy, Wi-Fi, frequency-shift keying (FSK) or Infrared Data Association (IrDA).

20. The method of claim 12, wherein the indication of the applied torque is output as an output signal, and the method further comprises converting the output signal to user-perceptible feedback by one or more transducers of the apparatus.

21. The method of claim 20, wherein the one or more transducers include an electromechanical transducer converting the output signal to haptic feedback, or an electroacoustic transducer converting the output signal to audible feedback.

22. The method of claim 20, wherein the one or more transducers include one or more electro-optical transducers converting the output signal to visual feedback, and the one or more electro-optical transducers include one or more light emitting diode (LED) indicators.
